(19) United States
(12) Patent Application Publication
(10) Pub. No.: US 2019/0113208 A1
(43) Pub. Date: Apr. 18, 2019

(54) DISPLAY DEVICE

(71) Applicant: InnoLux Corporation, Miao-Li County (TW)

(72) Inventors: Meng-Hsueh CHAN, Miao-Li County (TW); Yi-Fan CHIANG, Miao-Li County (TW); Chao-Yi HUNG, Miao-Li County (TW)

(21) Appl. No.: 16/104,258

(22) Filed: Aug. 17, 2018

(30) Foreign Application Priority Data
Oct. 12, 2017 (CN) 201710946839.8

(51) Int. Cl. F21V 13/00; F21V 7/00; F21V 3/10; F21V 9/32; F21V 3/12

(52) U.S. Cl. CPC F21V 13/00; F21V 7/005; F21Y 2115/10; F21V 9/32; F21V 3/12; F21V 3/10

(57) ABSTRACT

A display device includes a substrate, a light source, a reflecting structure, and an optical film set. The light source and the reflecting structure are disposed on the substrate. The reflecting structure has an opening, and the light source is correspondingly disposed in the opening. The optical film set is disposed on the reflecting structure, and at least part of the optical film set overlaps with the light source. The optical film set includes a semi-transmissive film disposed on the reflecting structure, a diffuser film disposed on the semi-transmissive film, and a conversion film disposed on the diffuser film.

### BACKGROUND

### 1. Technical Field

The present disclosure relates to a display device, and more particularly to a display device featuring improved light source module.

2. Description of Related Art

The current tendency for display device is toward being as thin or as lightweight as possible, providing light source module of good quality. However, these characteristics are hard to be balanced at the same time. For example, a direct backlight has advantages of high brightness, high contrast or true black, but it also occupies a substantial optical distance (OD) that makes its thinning relatively difficult. Actually, several attempts of research teams for thinning the direct backlight of a display device show that the necessary decrease of the optical distance nevertheless results in mura and leads to degraded display quality.

In view of this, there is a pressing need for a display device to improve the light source module of the aforementioned issues.

### SUMMARY

The present disclosure provides a display device that uses a well-designed optical film set to make the display device thin.

According to the present disclosure, the display device comprises: a substrate; a light source, a reflecting structure and an optical film set. The light source is disposed on the substrate; the reflecting structure is disposed on the substrate and has an opening, wherein the light source is correspondingly disposed in the opening; and the optical film set is disposed on the reflecting structure, and at least part of the optical film set overlaps with the light source. The optical film set includes a semi-transmissive film, a diffuser film, and a conversion film. The semi-transmissive film is disposed on the reflecting structure, and the diffuser film is disposed on the semi-transmissive film, and the conversion film is disposed on the diffuser film.

### BRIEF DESCRIPTION OF THE DRAWINGS

FIG. 1 is a cross-sectional view of a display device according to one embodiment of the present disclosure.

FIG. 2(a) is a top view of a substrate according to one embodiment of the present disclosure.

FIG. 2(b) is a cross-sectional view of the substrate of FIG. 2(a) taken along Line A-A′.

FIG. 3(a) is a cross-sectional view of a reflecting structure according to one embodiment of the present disclosure.

FIG. 3(b) is a cross-sectional view of a reflecting structure according to another embodiment of the present disclosure.

FIG. 3(c) is a cross-sectional view of a reflecting structure according to still another embodiment of the present disclosure.

FIG. 3(d) is a cross-sectional view of a reflecting structure according to yet another embodiment of the present disclosure.

FIG. 4 is a cross-sectional view of a light source module according to one embodiment of the present disclosure.

FIG. 5 is a cross-sectional view of a light source module according to another embodiment of the present disclosure.

FIG. 6 is a cross-sectional view of a light source module according to still another embodiment of the present disclosure.

FIG. 7 is a cross-sectional view of a light source module according to yet another embodiment of the present disclosure.

### DETAILED DESCRIPTION

The present disclosure will be described with reference to some embodiments and it is understood that the embodiments are not intended to limit the scope of the present disclosure. Moreover, as the contents disclosed herein should be readily understood and can be implemented by a person skilled in the art, all equivalent changes or modifications which do not depart from the concept of the present disclosure should be encompassed by the appended claims.

In the specification and the appended claims, the ordinal numbers like “first” and “second” are just descriptive to the elements following them and do not mean or signify that the claimed elements are such numbered, that one claimed element is arranged with another claimed element in that order, and that the claimed elements are produced in that order. These ordinal numbers are only used to help differentiate one claimed element having a denomination from another claimed element having the same denomination.

Furthermore, it is to be noted that, any description hereinafter using “when . . . ” or “at the time of . . . ” is intended to comprise a time “concurrent to, before, or after” the thing indicated by either of the two phrases happens. In addition, unless otherwise stated, any description using “disposed on the . . . ” or the like is intended only to indicate the relative positions of two or more elements, and by no means limits if these elements contact with each other or not. For the purpose of the present disclosure, the term “optical distance (OD)” refers to a height of the chamber in the light source module of a direct-lit display device, such as straight-line distance between the upper surface of the substrate to the lower surface of an adjacent optical film in the normal direction of the substrate, wherein the optical film may vary depending on different embodiments, e.g. a diffuser film or another optical film, without limitation. This will be explained in detail later. Moreover, when there are more effects recited in association with one element, component or assembly, as long as these effects are conjoined by the term “or”, any of these effects may be exist independently and the possibility of coexistence of plural such effects is ne excluded.

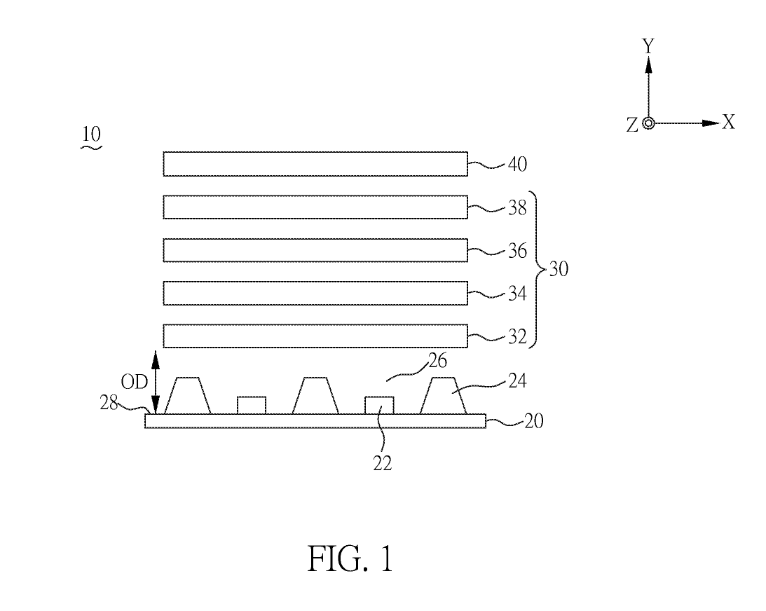

FIG. 1 is a cross-sectional view of a display device 10 according to one embodiment of the present disclosure. The disclosed display device 10 comprises: a substrate 20, an optical film set 30, and a display panel 40. The substrate 20 carries a plurality of light sources 22 and a reflecting structure 24. The reflecting structure 24 may have a plurality of openings 26 and may be made as an integratedly formed unity, and the light sources 22 are correspondingly disposed in the openings 26. As a non-limiting example, one light source 22 is correspondingly disposed in one opening 26, or plural light sources 22 are disposed in the same opening 26. In other embodiments, the reflecting structure 24 may be composed of plural sub-structures rather than made integratedly, and these sub-structures may be disposed close to the light sources 22. As can be seen in the top view, the distribution of plural sub-structures defines a plurality of openings 26, and the light source 22 may be correspondingly disposed in the openings 26, but the present disclosure is not limited thereto. The optical film set 30 is disposed on the reflecting structure 24, and at least part of the optical film set 30 overlaps with the light source 22. In one embodiment, the optical film set 30 may at least partially overlap with the light source 22 when viewed in a top view of the substrate in its normal direction. The optical film set 30 may have a semi-transmissive film 32, a diffuser film 34, and a conversion film 38, but the present disclosure is not limited thereto. The foregoing components of the optical film set 30 are only for an illustrative purpose, and can be added or omitted according to practical needs. For example, the optical film set 30 may further comprise a light-selecting film 36 disposed between the diffuser film 34 and the conversion film 38. For the clarity of explanation, the following description is made based on an optical film set 30 composed of a semi-transmissive film 32, a diffuser film 34, a light-selecting film 36, and a conversion film 38. The display panel 40 may be any of various display panels, touch display panels, or curved display panels, without limitation. The display panel 40 may be disposed on the optical film set 30. When the display device 10 is placed in the X-Z plane, which means its displaying surface faces the Y direction, the semi-transmissive film 32, the diffuser film 34, the light-selecting film 36 and the conversion film 38 may be arranged in the Y direction in order. For easy understanding, the following description is made based on that the display device 10 is placed in the X-Z plane, and whenever the phrase “disposed on the . . . ” is referred, the relevant movement is made in the Y direction.

In one embodiment, the semi-transmissive film 32 may be disposed on the reflecting structure 24, and the diffuser film 34 may be disposed on the semi-transmissive film 32, the light-selecting film 36 may be disposed on the diffuser film 34, and the conversion film 38 may be disposed on the light-selecting film 36. In other words, the semi-transmissive film 32 may be close to the substrate 20, and the conversion film 38 may be close to the display panel 40. In one embodiment, the semi-transmissive film 32 reflects some light and allows some light to pass therethrough; the diffuser film 34 diffuses light; the light-selecting film 36 allow light of certain wavelengths to pass therethrough and reflects light of the other wavelengths; and the conversion film 38 converts incident light in terms of wavelength, without limitation.

In one embodiment, the light source 22 may be made of light-emitting diodes (LEDs), micro light-emitting diodes (micro LEDs), mini light-et fitting diodes (mini LEDs), quantum dots (QD) material, fluorescent material, phosphorescent material, or any combination thereof or any other material suitable for such a light source, without limitation. In one embodiment, the light from the light source 22 may directly enter the optical film set 30 or first be partially reflected by the reflecting structure 24 and then enter the optical film set 30. The optical film set 30 may adjust the light from the light source 22 or the light from the reflecting structure 24, and the light adjusted by the optical film set 30 may become the light source module for the display panel 40. In this case, the substrate 20 and the optical film set 30 may be jointly deemed as the light source module of the display device 10, and the combination of the light source module and the display panel 40 may be jointly deemed as the display device 10.

The substrate 20, the light source 22, the reflecting structure 24, the semi-transmissive film 32, the diffuser film 34, the light-selecting film 36 and the conversion film 38 will be described in detailed below.

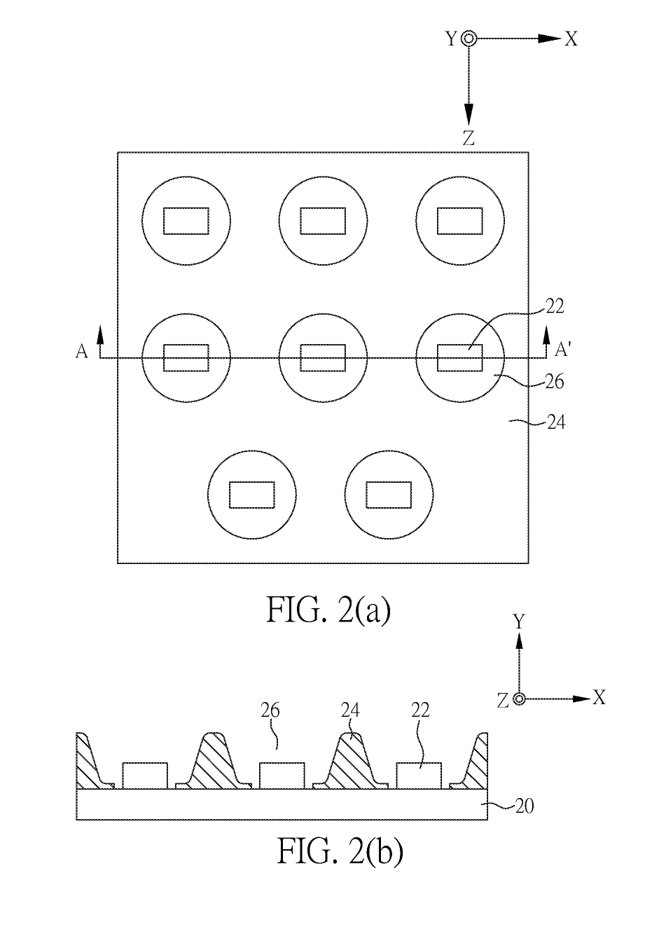

The substrate 20 in the light source module may be made of any suitable material, such as glass, a printed circuit board (PCB), a flexible printed circuit board (FPC), or another suitable material, or any combination thereof, without limitation. The light source 22 may be disposed on the substrate 20, and the light source 22 may a blue light source, but the present disclosure is not limited thereto. In other embodiments, the light source 22 may be a light source of another color, or a combination of multiple colors, without limitation. The reflecting structure 24 may be disposed on the substrate 20. It reflects light or change the path of light to alleviate mura phenomena occurred due to the reduced the ratio of OD:Pitch (i.e. the ratio of the optical distance and the light source pitch). The reflecting structure 24 may be made of material having high reflectivity, of photo-resistant material, of a substrate coated with material of high reflectivity, of a substrate combined with material of high reflectivity, or of material doped with reflective particles, without limitation. In one embodiment, the reflective particles may have different particle sizes or be of different materials, or may be composite material, such as one containing titanium dioxide (TiO₂), silicon dioxide (SiO₂), aluminum oxide (A1₂O₃) or zinc oxide (ZnO). In one embodiment, the reflecting structure 24 may be made using injection molding or thermal forming for plastic material, and then be laminated to the substrate 20 preinstalled with the light source 22 (e.g., the aspect shown in FIG. 2(b)). In another embodiment, the reflecting structure 24 may be made using a lithography etching process into an integrated reflecting structure 24 that has a plurality of openings (e.g., the aspects shown in FIGS. 1, 3, 4, 5, 6 and 7). Alternatively, the reflecting structure 24 may be made using a lithography etching process into a plurality of patterned sub-structures that are arranged to define a plurality of openings, without limitation. The material of high reflectivity may have a reflectivity in a range between 80 and 100% (80≤Reflectivity≤100%), without limitation.

In one embodiment, the light source 22 may in the Y direction be lower than the reflecting structure 24. Stated differently, in the Y direction, the reflecting structure 24 has its top closer to the optical film set 30 than the top of the light source 22 is, but the present disclosure is not limited thereto. In one embodiment, the semi-transmissive film 32 and the reflecting structure 24 contact each other, and the reflecting structure 24 may, in Y direction, be higher than the light source 22. Thus, there is a distance between the semi-transmissive film 32 and the light source 22, but the present disclosure is not limited thereto. The reflecting structure 24 may reflect the light emitted by the light source 22 and change its path, so as to even uniformize the light, thereby ensuring even brightness of the resulting light source module uniformize. More details of the reflecting structure 24 will be described below.

For the purpose of the present disclosure, the term “optical distance (OD)” refers to a height of the chamber in the light source module of a direct-lit display device. This can be also described as, in the Y direction, the straight line distance in the normal direction of the substrate 20 between the upper surface 28 of the substrate 20 and the bottom (lower surface) of the adjacent optical film set 30. The term “pitch” between light sources refers to the distance between the center points of two adjacent two light sources 22 arranged in series on the substrate 20, or the distance between adjacent two light sources 22 at their corresponding side (such as the left side of each of the adjacent two light sources 22). The OD:Pitch ratio of the optical distance to the light source pitch may be between 0.1:1 and 1:1. In some embodiments, the ratio of the optical distance to the light source pitch may be 0.144:1. In addition, In one embodiment, the optical distance in the present disclosure may be in a range between 1.8 and 24 mm. In one embodiment, optical distance in a range between 0 mm and 15 mm (0 mm≤OD≤15 mm). In one embodiment, optical distance in a range between 0 mm and 10 mm (0 mm≤OD≤10 mm). In one embodiment, optical distance may be in a range between 0 mm and 5 mm (0 mm≤OD≤5 mm). In a traditional display device, the ratio of the optical distance to the light source pitch is about 1.2:1, and the optical distance is about 24 mm. By comparison, the direct-lit display device of the present embodiment has a smaller ratio of the optical distance to the light source pitch, or has a smaller optical distance, thereby being favorable to making the resulting display device thinner.

The semi-transmissive film 32 allows part of light to pass therethrough, and reflects the rest of the light. At least part of semi-transmissive film 32 may contact with the reflecting structure 24. Where the semi-transmissive film 32 is disposed on the reflecting structure 24, part of the light emitted by the light source 22 is reflected by the semi-transmissive film 32, so the path or direction of the light traveling between the semi-transmissive film 32 and the reflecting structure 24 is changed, making light distribution evener. In one embodiment, the semi-transmissive film 32 may be a translucent film, or may be made of a translucent material. The semi-transmissive film 32 may have a transmittance in a range between 30% and 70% (30%≤Transmittance≤70%), but the present disclosure is not limited thereto. The semi-transmissive film 32 may be, for example, a transparent substrate partially coated with scattering material, a multilayer film, or a substrate provided with fine irregularities. In one embodiment, the semi-transmissive film 32 may also have plural apertures so that part of light is allowed to pass and the rest of the light is reflected. In this case, the semi-transmissive film 32 may be made of a total-refection reflection material that is, but the present disclosure is not limited thereto.

The diffuser film 34 may scatter light entering the optical film, so as to further uniformize light diffusion, thereby alleviate mura phenomena occurred caused by the reduced ratio of the optical distance to the light source pitch (OD:Pitch). The diffuser film 34 may be disposed on the semi-transmissive film 32. In one embodiment, the diffuser film 34 may contact the semi-transmissive film 32, but the present disclosure is not limited thereto. The diffuser film 34 may comprise a diffuser sheet, a diffuser plate, or another film with similar functions, without limitation. The diffuser film 34 may have a haze value in a range between 80% and 99% (80%≤haze value≤99%), but the present disclosure is not limited thereto. In one embodiment, the diffuser film 34 may be made of any feasible method and any suitable material, such as made by coating a layer of diffusing material on the optical film, or forming irregularities on the surface of the optical film, adding scattering particles, diffusing particles or reflecting particles to the optical film, doping the optical film with hollow beads or polymer particles filled with air or gas, forming the optical film of a microvoid structure, any combination of the foregoing, or using another suitable material, without limitation.

The light-selecting film 36 may not only allow light of particular wavelengths to pass through the light-selecting film 36, but also reflects light of the other wavelengths. The light-selecting film 36 may be disposed on the diffuser film 34. In one embodiment, the light-selecting film 36 may contact the diffuser film 34, but the present disclosure is not limited thereto. In one embodiment, the light-selecting film 36 may be a splitter film, such as a wavelength-based splitter film, intensity-based splitter film or a polarizing splitter film, without limitation. In one embodiment, the light-selecting film 36 may be a wavelength-based splitter film, which allows light of different wavelengths to pass therethrough or to be reflected based on a predetermined wavelength range. In one embodiment, the light-selecting film 36 may be blue light splitter film that allows blue light to pass through the blue light splitter film and reflects light of other wavelengths, but the present disclosure is not limited thereto. In one embodiment, the blue light splitter film may allow light having a wavelength in a range between 400 nm and 500 nm (400 nm≤Wavelength≤500 nm) to pass through the blue light splitter film and reflects light having a wavelength out of this range. The light-selecting film 36 may be, for example, a multilayer film containing a plurality of different indexes of refraction, different levels of thickness, different dielectric coefficients, or different phase difference, or any combination of the foregoing material, without limitation.

The conversion film 38 may make the incident light different from the light that has gone through the conversion film 38 in terms of wavelength. The conversion film 38 may be disposed on the light-selecting film 36. In one embodiment, the conversion film 38 may contact light-selecting film 36, but the present disclosure is not limited thereto. In one embodiment, the conversion film 38 may comprise a photoconversion material that can be excited by the incident light to generate light of different wavelengths. For example, blue light may excite red fluorescent material to generate red light, but the present disclosure is not limited thereto. In one embodiment, the photoconversion material in the conversion film 38 may, for example, comprise fluorescent material, phosphorescent material, quantum dot material, another suitable material, or any combination of the same, without limitation. In one embodiment, the fluorescent material may be organic fluorescent material or inorganic fluorescent material, without any limitation. In one embodiment, the phosphorescent material may be organic phosphorescent material or inorganic phosphorescent material, without limitation.

With the semi-transmissive film 32, the diffuser film 34, the light-selecting film 36 and the conversion film 38 arranged in order in the Y direction, the light emitted by the light source 22 can be repeatedly reflected, refracted or scattered so as to enhance brightness or uniformize light distribution, thereby improving the light source module quality of the display panel 40.

The following description will be directed to the arrange of the openings 26 and the light sources 22 on the reflecting structure 24 of the substrate 20 with reference to FIG. 1 as well. FIG. 2(a) is a top view of the substrate 20 according to one embodiment of the present disclosure and shows how the light sources 22 correspond to the openings 26 in the X direction and in the Z direction. In the present embodiment, a single light source 22 is correspondingly disposed in an opening 26, but in other embodiments, plural light sources 22 are correspondingly disposed in an opening 26, without limitation. Additionally, the light sources 22 may or may not be of the same type. For example, the light sources 22 may have different colors or may be made of different materials. In addition, there is no limitation about the shape of the opening 26, and the opening 26 may be round, rectangular, irregular or of any combination of the foregoing shapes. Furthermore, there is no limitation about the size of each opening 26.

Moreover, the openings 26 may be arranged correspondingly. For example, the first opening 26a and the second opening 26b may be arranged correspondingly in the Z direction. Alternatively, the openings 26 may be arranged at random. For example, the second opening 26b and the third opening 26c may be staggered arranged. The present embodiment is merely illustrative. In practical applications, the substrate 20 may be provided with more light sources 22 and more openings 26, thereby forming an aspect of direct backlight.

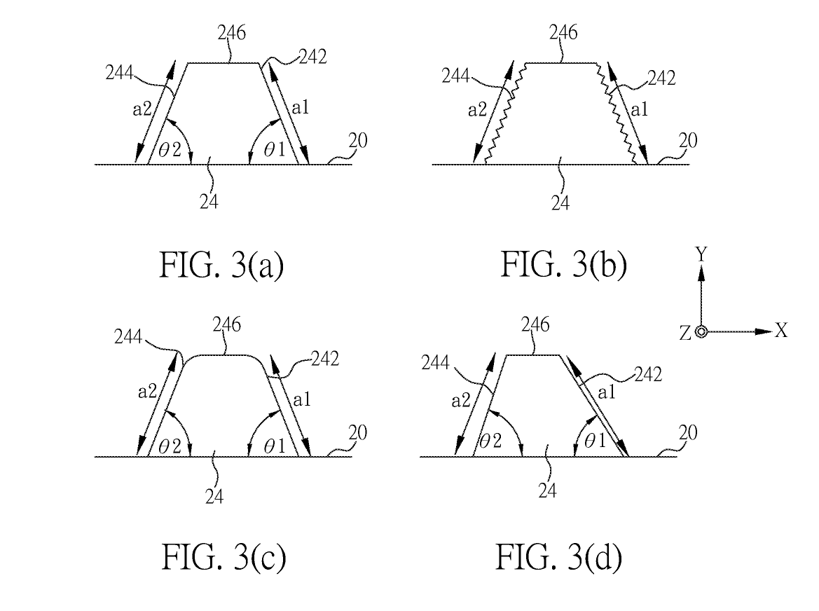

FIG. 2(b) is a cross-sectional view of the substrate 20 of the display device of FIG. 2(a) taken along Line A-A′. This cross section is defined by a cross-sectional line crossing plural openings 26 in the normal direction of the substrate 20 (i.e. a plane facing the X direction and the Z direction). For example, it is a cross section defined by Line A-A′ crossing plural openings 26. As shown in FIG. 2(b), the reflecting structure 24 may have a lateral close to the light source 22. The lateral and the substrate may jointly include an included angle (shown in FIGS. 3(a) through 3(d)).

The following description will be directed to the reflecting structure 24 with reference to FIG. 1 through FIG. 3(d).

FIG. 3(a) is a cross-sectional view of a reflecting structure 24 according to one embodiment of the present disclosure. This cross section is defined by Line A-A′ crossing plural openings 26 (similar to the cross-sectional view of FIG. 2(b)). In the present embodiment, the cross section of the reflecting structure 24 taken along Line A-A′ may be a trapeziform structure. This trapezium structure has a first lateral 242 and a second lateral 244. (In some embodiment, the first lateral 242 and the second lateral 244 are deemed as legs of the trapeziform cross section). The first lateral 242 and the substrate 20 jointly include a first included angle θ1. The second lateral 244 and the substrate 20 jointly include a second included angle θ2. In one embodiment, the first included angle θ1 and the second included angle θ2 may be both acute angles, so that the cross section of the reflecting structure 24 is like a trapezium, which can guide the light from the light source 22 into the optical film set 30 in a more distributed manner. In one embodiment, the first included angle θ1 and the second included angle θ2 may be identical, meaning that the first lateral 242 and the second lateral 244 have the same slope. In another embodiment, the first included angle θ1 and the second included angle θ2 may each be in a range between 30 degrees and 90 degrees (i.e. 30°≤θ1<90° and 30°≤θ2<90°), but the present disclosure is not limited thereto. In the present embodiment, where the first lateral 242 or the second lateral 244 of the cross section is defined in the Cartesian coordinate system, the first lateral 242 or the second lateral 244 satisfies the following formula:

y=mx+(−0.83)

where, m is the slop of the first lateral 242 or the second lateral 244 of this cross section, and the absolute value of m is between 1.21 and 1.23 (i.e. 1.21≤|m|≤1.23). Therein, (x,y) is defined as coordinates on the first lateral 242 or the second lateral 244 of the cross section, and the origin is defined as the joint between the first lateral 242 or the second lateral 244 of the cross section and the substrate 20.

More particularly, the first lateral 242 satisfies the formula: y=a1x+(−0.83), where a1 is the slope of the first lateral 242, and a1 is between −1.21 and −1.23 (i.e. −1.23≤a1≤−1.21), and (x,y) is defined as coordinates in the first lateral 242. At this time, the origin is defined as the joint between the first lateral 242 and the substrate 20. Furthermore, the second lateral 244 satisfies another formula: y=a2x+(−0.83), where a2 is the slope of the second lateral 244, and a2 is between 1.21 1.23 (i.e. 1.21≤a2<1.23). Therein, (x,y) is defined as coordinates on the second lateral 244, and at this time the origin is defined as the joint between the second lateral 244 and the substrate 20. In the present embodiment, the absolute value of the slope of the first lateral 242 is equal to the absolute value of the slope of the second lateral 244, so the reflecting structure 24 may be deemed as an isosceles trapezium.

FIG. 3(b) is a cross-sectional view of a reflecting structure 24 according to another embodiment of the present disclosure. In the present embodiment, the reflecting structure 24 is like a trapezium in the cross section taken along Line A-A′, and the first lateral 242 or the second lateral 244 may have a plurality of micro-structures. However, in general (such as viewed from far), the first lateral 242 or the second lateral 244 still has a substantial slope. The first lateral 242 or the second lateral 244 may substantially satisfy the formula as described with reference to FIG. 3(a). For example, in this cross section, the absolute value of the slope of the first lateral 242 or the second lateral 244 may be between 1.21 and 1.23 (i.e. 1.21≤a2≤1.23). Where the first lateral 242 or the second lateral 244 has plural micro-structures, reflection of light may increase so that the illumination is of enhanced evenness.

FIG. 3(c) is a cross-sectional view of a reflecting structure 24 according to still another embodiment of the present disclosure. In the present embodiment, the reflecting structure 24 is like a trapezium in the cross section taken along Line A-A′. The first lateral 242 or the second lateral 244 is substantially a straight line, but the joint between the first lateral 242 or the second lateral 244 and the top surface 246 of the reflecting structure 24 forms a fillet or arc, wherein the top surface 246 is located between the first lateral 242 and the second lateral 244. According to the present embodiment, although the included angle between the first lateral 242 or the second lateral 244 and the top surface 246 in this cross section is not defined by straight lines, it in general (such as viewed from far) has a substantial slope, and the first lateral 242 or the second lateral 244 substantially satisfies the formula as described with reference to FIG. 3(a).

FIG. 3(d) is a cross-sectional view of a reflecting structure 24 according to yet another embodiment of the present disclosure. In the present embodiment, the cross section of the reflecting structure 24 taken along Line A-A′ is not an isosceles trapezium because the first lateral 242 and the second lateral 244 have different slopes and the first included angle θ1 is different from the second included angle θ2. In addition, the first lateral 242 or the second lateral 244 of the present embodiment still satisfies the formula as described with reference to FIG. 3(a), but the absolute value of the slop of the first lateral 242 is different from that of the second lateral 244. Moreover, first included angle θ1 or the second included angle θ2 of the present embodiment may be between 30 degrees and 90 degrees(i.e. 30°≤θ1<90°, 30°≤θ2<90°, and θ1≠θ2).

The foregoing embodiments of the reflecting structure 24 are illustrative and the features of each of these embodiments may be matched, displaced, or combined, and additional variations are possible, without limitation.

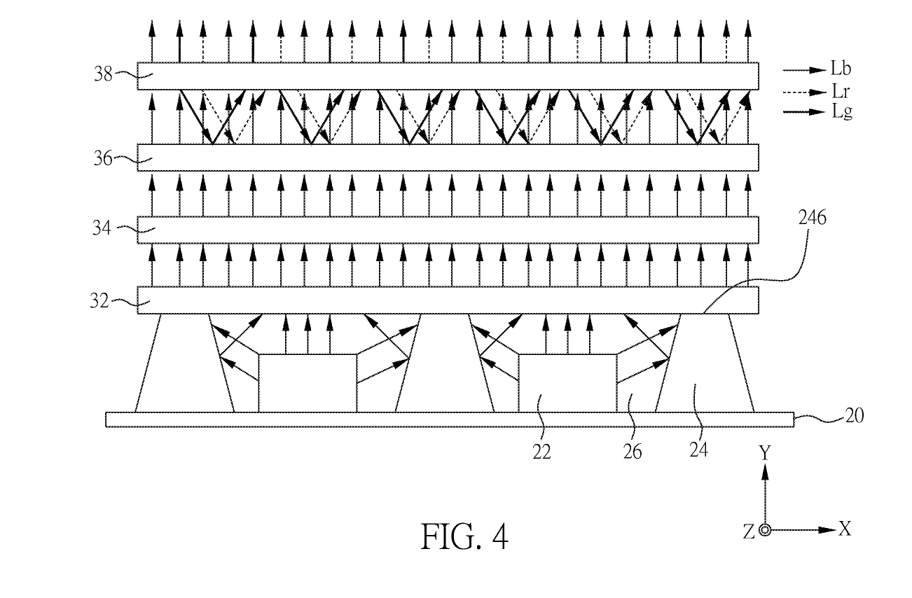

The following description will be directed to the operation of the light source module of the display device 10 of the present disclosure. FIG. 4 is a cross-sectional view of a light source module according to one embodiment of the present disclosure. Please also refer to FIG. 1 through FIG. 4. For better clarity, the semi-transmissive film 32, the diffuser film 34, the light-selecting film 36, and the conversion film 38 of the present embodiment are separated to show the evolution of light, but they may be actually in close contact with each other. For example, the semi-transmissive film 32 may contact the diffuser film 34, the diffuser film 34 may contact the light-selecting film 36, and the light-selecting film 36 may contact the conversion film 38, but the present disclosure is not limited thereto. The top surface 246 of the reflecting structure 24 of the present embodiment may contact the semi-transmissive film 32, but the present disclosure is not limited thereto. In addition, although in the present embodiment the light source 22 emits blue light (Lb) and the light-selecting film 36 is a blue light splitter film, the present disclosure is applicable to a light source 22 emitting light of a different wavelength and a light-selecting film 36 that selects differently.

Some blue light (Lb) emitted between the substrate 20 and the semi-transmissive film 32, 22 is reflected by the reflecting structure 24 and changes its path when entering the semi-transmissive film 32. Thereby, mura phenomena occurred caused by the reduced OD:Pitch ratio of the optical distance and the light source pitch can be alleviated.

When the blue light (Lb) enters the semi-transmissive film 32, part of the blue light (Lb) is reflected by the semi-transmissive film 32, and then reflected by the reflecting structure 24 back to the semi-transmissive film 32. This makes the blue light (Lb) enter the semi-transmissive film 32 in an evener manner, thereby uniformizing the light, so as to alleviate mura phenomena occurred caused by the reduced OD:Pitch between the optical distance and the light source pitch.

When the blue light (Lb) that has passed through the semi-transmissive film 32 comes to the diffuser film 34, the blue light (Lb) is scattered by the diffuser film 34, making the blue light (Lb) spread. Thereby, mura phenomena occurred caused by the reduced OD: Pitch between the optical distance and the light source pitch can be alleviated. When the blue light (Lb) that has passed through the diffuser film 34 comes to the light-selecting film 36, since the light-selecting film 36 is now a blue light splitter film, the blue light (Lb) can pass through the light-selecting film 36, but the present disclosure is not limited thereto. In one embodiment, the wavelength range based on which the light-selecting film 36 works may be selected according to the practical need for the light source 22 or the desired light source module effect.

When the blue light (Lb) that has passed through the light-selecting film 36 comes to the conversion film 38, part of the blue light (Lb) excites the photoconversion material in the conversion film 38 to generate light of other wavelengths, and the rest of the blue light (Lb) passes through the conversion film 38. In the present embodiment, the conversion film 38 may comprise red fluorescent material and green fluorescent material, and may be excited by blue light (Lb) to generate red light (Lr) and green light (Lg). The blue light (Lb), red light (Lr) and green light (Lg) that have passed through the conversion film 38 are mixed into white light to be used as light source module for a display device. Since the red light (Lr) and green light (Lg) generated by the conversion film 38 may partially march toward the light-selecting film 36, this part of the red light (Lr) and green light (Lg) may be reflected by the light-selecting film 36 (which may be a blue light splitter film) and mixed with blue light (Lb) to generate white light, making the light source module more desirable.

Thereby, the display device 10 can be made thin without compromising the good quality of the light source module. In addition, the foregoing embodiment is illustrative and not intended to limit the present disclosure in any case. For example, in another embodiment where the light source 22 is a white light source itself, the optical film set 30 may be structurally modified by, for example, removing the conversion film 38, removing the light-selecting film 36 or alternatively using a light-selecting film that only allows light of a white-light wavelength to pass therethrough.

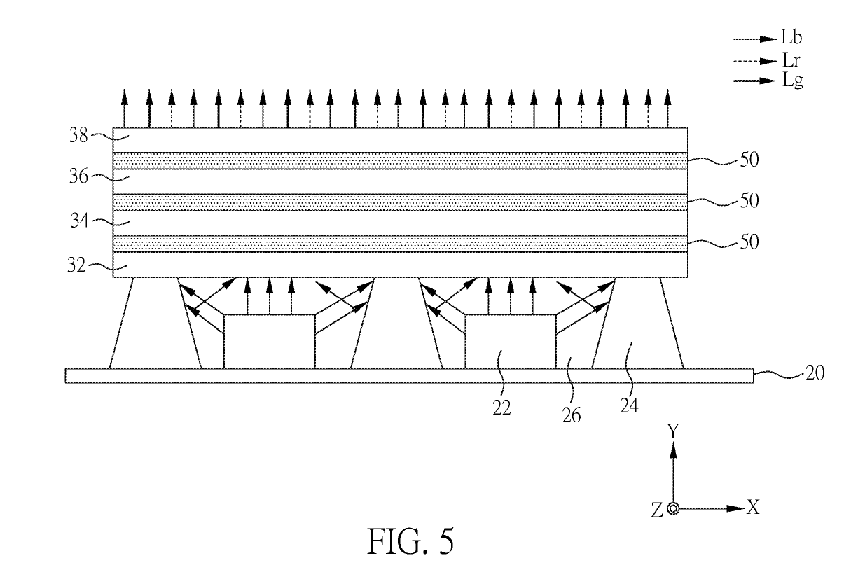

FIG. 5 is a cross-sectional view of a light source module according to another embodiment of the present disclosure. In this embodiment, the display device 10 may include a substrate 20, a light source 22, a reflecting structure 24, a semi-transmissive film 32, a diffuser film 34, the light-selecting film 36, and a conversion film 38. These components may be arranged in the way similar to that seen in the previous embodiment. The present embodiment is different from the previous embodiment for the fact that an adhesive member 50 is filled between the semi-transmissive film 32 and the diffuser film 34, between the diffuser film 34 and the light-selecting film 36, and between the light-selecting film 36 and the conversion film 38 for firm combination. In one embodiment, the adhesive member 50 may be an optical adhesive that allows light to pass therethrough, and is made of optical clear adhesive (OCA), polyvinyl butyral resin (PVB), ethylene vinyl acetate (EVA), other suitable material, or any combination thereof, without limitation.

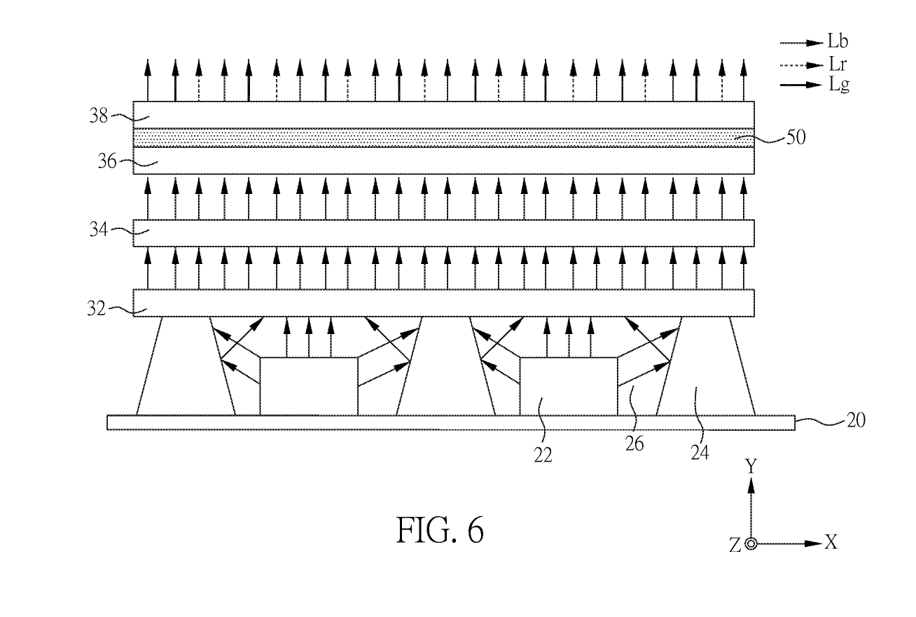

FIG. 6 is a cross-sectional view of a light source module according to still another embodiment of the present disclosure. The present embodiment is structurally similar to its counterpart shown in FIG. 5 with the difference that the adhesive member 50 in the present embodiment is only filled between the light-selecting film 36 and the conversion film 38. The present embodiment is illustrative and not limiting. In fact, the adhesive member 50 may be selectively tilled between semi-transmissive film 32 and diffuser film 34, between the diffuser film 34 and the light-selecting film 36, and between the light-selecting film 36 and the conversion film 38 according to practical needs, without limitation.

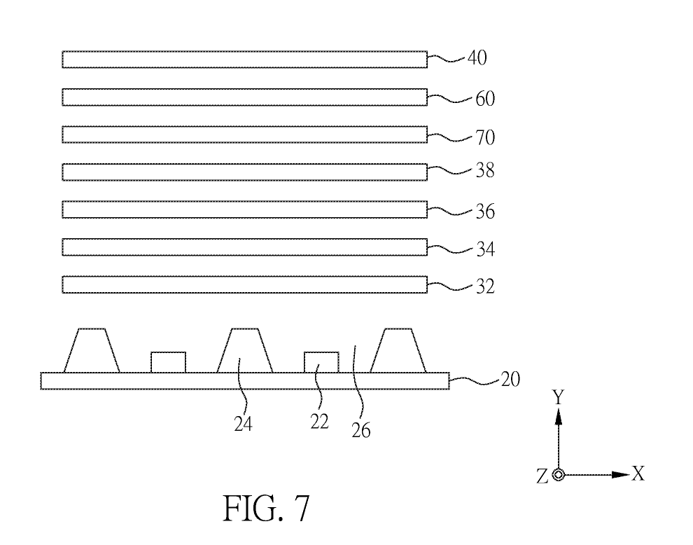

FIG. 7 is a cross-sectional view of a display device 10 according to yet another embodiment of the present disclosure. The present embodiment may be applied to any of the foregoing embodiments and features that additional components may be arranged between the display panel 40 and the optical film set 30, such as a first brightness enhancement film 60, a second brightness enhancement film 70, or a combination of the first brightness enhancement film 60 and the second brightness enhancement film 70, thereby making the light source module of the display device 10 more desirable. In one embodiment, the first brightness enhancement film 60 may be a reflective brightness enhancement film, or another film having similar functions, without limitation. In one embodiment, the second brightness enhancement film 70 may be a prism-type brightness enhancement film, or other films providing similar functions, without limitation.

The display device 10 made according to any of the foregoing embodiments of the present disclosure may be used with a touch panel to form a touch display. Furthermore, the display device or touch display device made in accordance with any of the foregoing embodiments of the present disclosure may be applied to any electronic devices known in the art that use a display screen to display images, such as displays, mobile phones, notebooks, tiled display, video cameras, still cameras, music displays, mobile navigators, TV sets, automobile dashboards, center console, electronic rearview mirrors, head-up displays and so on.

Thereby, the present disclosure provides an improved display device 10 that satisfies the needs of thinning or quality light source module for the display device 10 in virtue of the special elements or special arranges of its elements.

The present disclosure has been described with reference to the preferred embodiments and it is understood that the embodiments are not intended to limit the scope of the present disclosure. Moreover, as the contents disclosed herein should be readily understood and can be implemented by a person skilled in the art, all equivalent changes or modifications which do not depart from the concept of the present disclosure should be encompassed by the appended claims.

What is claimed is:

1. A display device, comprising:
a substrate;
a light source, being disposed on the substrate;
a reflecting structure, being disposed on the substrate and having an opening, wherein the light source is correspondingly disposed in the opening; and
an optical film set, disposed on the reflecting structure, and at least part of the optical film set overlapping with the light source;
wherein, the optical film set includes a semi-transmissive film, a diffuser film and a conversion film, the semi-transmissive film is disposed on the reflecting structure, the diffuser film is disposed on the semi-transmissive film, and the conversion film is disposed on the diffuser film.

2. The display device of claim 1, wherein the optical film set further comprises a light-selecting film disposed between the diffuser film and the conversion film.

3. The display device of claim 2, wherein at least part of the semi-transmissive film is in contact with the reflecting structure.

4. The display device of claim 2, wherein the reflecting structure has, on its cross section, a lateral close to the light source, and the lateral and the substrate jointly include an included angle in a range between 30 degrees and 90 degrees.

5. The display device of claim 2, wherein the semi-transmissive film has a transmittance in a range between 30% and 70%.

6. The display device of claim 2, wherein the diffuser film has a haze value in a ranee between 80% and 99%.

7. The display device of claim 2, wherein the light-selecting film allows light having a wavelength in a range between 400 nm and 500 nm to pass through the light-selecting film.

8. The display device of claim 2, wherein the conversion film comprises a fluorescent material, a phosphorescent material, or a quantum dot material.

9. The display device of claim 2, further comprising an adhesive member filled between the semi-transmissive film and the diffuser film, between the diffuser film and the light-selecting film, or between the light-selecting film and the conversion film.

10. The display device of claim 1, wherein an optical distance separating the substrate from the optical film set is in a range between 0 mm and 15 mm.

11. The display device of claim 2, wherein the light source is a combination of multiple colors.

12. The display device of claim 2, wherein a single light source is correspondingly disposed in an opening 26.

13. The display device of claim 2, wherein plural light sources are correspondingly disposed in an opening 26.

14. The display device of claim 2, wherein the openings are staggered arranged.

15. The display device of claim 2, wherein the cross section of the reflecting structure is a trapeziform structure.

16. The display device of claim 1, wherein the cross section of the reflecting structure is trapeziform structure, and the trapeziform structure has a first lateral and a second lateral.

17. The display device of claim 16, wherein the first lateral and the second lateral have the same slope.

18. The display device of claim 1, wherein the reflecting structure have a reflectivity in a range between 80 and 100%.

19. The display device of claim 17, wherein the absolute value of the slop of the first lateral or the second lateral of the cross section is between 1.21 and 1.23.
